(19) United States
(12) Patent Application Publication
(10) Pub. No.: US 2003/0209315 A1
(43) Pub. Date: Nov. 13, 2003

(54) Process for adhering a component on a counter surface and apparatus therefor

(75) Inventor: Jochen Schneegans, Wittgert (DE)

Correspondence Address: CROWELL & MORING LLP, INTELLECTUAL PROPERTY GROUP, P.O. BOX 14300, WASHINGTON, DC, 20044-4300, US

(73) Assignee: FFT Flexible Fertigungstechnik GmbH & Co. KG, Muecke (DE)

(21) Appl. No.: 10/465,765

(22) Filed: Jun. 20, 2003

Related U.S. Application Data
(63) Continuation of application No. 09/924,107, filed on Aug. 8, 2001, now abandoned.

(30) Foreign Application Priority Data
Aug. 8, 2000 (DE) 100 38 516.8

(51) Int. Cl. B32B 31/00

(52) U.S. Cl. 156/247; 156/580

(57) ABSTRACT

While a protective film (4) is being pulled off from an adhesive layer (3) of a component (2), a stream of ionized gas is blown with an ion blower (7) into the gap (6), which opens up between the adhesive layer (3) and the protective layer (4) while the latter is being pulled off. Electrostatic charges, which are developed during the pulling off, are neutralized immediately by these means.

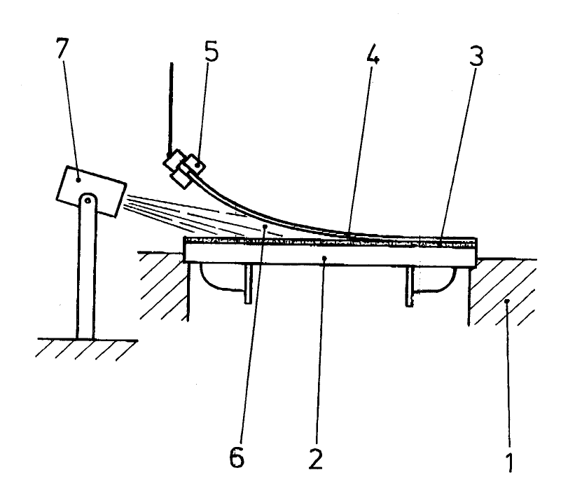

The invention relates to a method for adhering a component, which is provided with an adhesive layer and a protective film, to a counter-surface, for which initially the protective film is removed and the component is then pressed to a counter-surface, especially for adhering a rain sensor to a windshield of a motor vehicle. Moreover, the invention relates to an apparatus for practicing this method.

In the case of components, which are provided with an adhesive layer, a protective film, which is on the adhesive layer, is usually pulled off immediately before the component is adhered to another component and, subsequently, the component with the adhesive layer is pressed against the surface, to which it is to be adhered. In so doing, care must be taken to ensure that, when the protective film is pulled off, dust does not reach the adhesive layer, since it would affect the quality of the adhesion.

If a component must be adhered to a glass surface, such as a rain sensor or an interior mirror to the inside of a windshield, then the special feature arises that the adhesive layer remains visible through the windshield. Usually, the adhesive layer is black, so that it is not undesirably obtrusive optically in the area of the black imprint on the windshield. However, if dust particles reach the adhesive layer after the protective film is pulled off, then these are visible as bright points on the black adhesive layer after the gluing. This is not attractive and gives the appearance of inferior processing.

In the past, attempts have been made to avoid such contaminations by carrying out the gluing of the component in as clean an environment as possible. However, this brings about only limited success. In the case of rain sensors, for example, the supporting plate consists of plastic. It has, therefore already been suggested that electrostatic charges on the plastic part could be the cause for the attraction of dust particles. Such components, after the protective film has been pulled off, have been discharged electrostatically by means of an ion blower. However, this has also not brought about complete success. Better results with respect to the absence of dust arise if components are selected with a protective film of an electrically conductive material. However, such protective films are appreciably more expensive than plastic protective films.

It is a first object of the invention, to develop a method for adhering a component, which has been provided with an adhesive layer, in such a manner that the danger of the deposition of dust particles on the adhesive layer are as small as possible after the protective film has been pulled off. Moreover, an apparatus is provided for practicing the method in a second object of the invention.

Pursuant to the invention, the first object is accomplished owing to the fact that, while the protective film is being pulled off, a stream of ionized gas is blown with an ion blower into the gap between the adhesive layer and the protective film, which opens up during the pulling off of the protective film.

The second object is accomplished owing to the fact that the device has an ion blower which is aligned to the gap between the adhesive layer and the protective film, which opens up during the pulling off of the protective film.

This method and the inventive device are based on the knowledge that, when a protective film is pulled from a component, the latter develops an electrostatic charge, which can be so strong that, during or immediately after the pulling off, dust particles are attracted and reach the adhesive layer. Pursuant to the invention, a stream of ionized gas is blown on the adhesive layer already while the protective film is being pulled off, so that there is neutralization or even dust-rejecting charging already during the development of the electrostatic charge. Complete cleanliness of the adhesive layer can therefore be attained even without having to place excessively high requirements on the cleanliness of the surroundings, in which the adhering of the components takes place. The inventive method is therefore particularly suitable for adhering rain sensors to the inside of a windshield.

For the further clarification of the invention, the procedure for pulling the protective film from a component is shown in the drawing and described in the following.

The drawing shows a clamping part 1, with which a component 2, which is a rain sensor for a vehicle, is clamped. The component 2 has an adhesive layer 3, which initially is covered by a protective film 4. The drawing shows that this protective film 4 is removed by means of a gripper 5 from the adhesive layer 3.

While the protective film 4 is being pulled off, a gap 6, which expands in cross section to the side, is formed between the film 4 and the adhesive layer 3. It is important for the inventive method and the corresponding device that ionized air is blown into this gap 6 by means of an ion blower 7 while the protective film 4 is being pulled off. By these means, the electrostatic charge, developed while the protective film 4 is being pulled off, is neutralized immediately.

1. A method for adhering a component, which is provided with an adhesive layers and a protective film, to a counter-surface, for which initially the protective film is removed and then the components is pressed against the counter-surface especially, for adhering a rain sensor to the windshield of a motor vehicle, wherein, while the protective film is being pulled off, a stream of ionized gas is blown which an ion blower into the gap opening up between the adhesive layer and the protective film, while the latter is being pulled off.

2. A device for implementing the method of claim 1, which has clamping means for holding a component and a gripper for gripping and pulling off a protective film from an adhesive layer of the component, wherein the device additionally has an ion blower (7), which is directed towards the gap (6), which opens up between the adhesive layer (3) and the protective film (4), while the latter is being pulled off.
